(19) United States
(12) Patent Application Publication
(10) Pub. No.: US 2005/0233157 A1
(43) Pub. Date: Oct. 20, 2005

(54) Device and system for coating a surface

(76) Inventor: Lewyn B. Boler JR., Stockton, CA (US)

Correspondence Address: DIDRIKSEN LAW FIRM, 3114 CANAL STREET, NEW ORLEANS, LA, 70119, US

(21) Appl. No.: 10/518,967

(22) PCT Filed: Jun. 21, 2002
(86) PCT No.: PCT/US02/20031

§ 371 Date: Dec. 21, 2004

(51) Int. Cl. B32B 25/02; B05D 1/28

(52) U.S. Cl. 428/447; 428/409; 427/429

(57) ABSTRACT

A system for applying a protective coating to a surface includes a device for applying a protective coating to a surface. The device includes a composite having a matrix that includes at least one polymer resin chosen from the following group: hydrocarbon, polybutene, silicone, polyethylene; at least one silicone fluid; at least one surface coating chosen from the following groups: wax, silicone resin; and a multiplicity of inert particles dispersed within the matrix. The composite has a wax penetration point measurement from about 60 mm to about 250 mm at 25 degrees Celsius under ASTM Test Method D217, and the device is adapted so that the device, when rubbed uppon a surface, leaves a surface coating on the surface. The invention also may take the form of a system that includes an applicator pad and a rejuvenator fluid containing a silicone and a wax.

### CROSS-REFERENCE TO RELATED APPLICATIONS

Not applicable.

### COPYRIGHT STATEMENT

Not applicable.

### FEDERAL RESEARCH STATEMENT

Not applicable.

### TECHNICAL FIELD

This invention relates to the field of applying lustrous protective coatings such as waxes and silicones to coated and uncoated surfaces such as metal, plastic, plexiglass®, formica®, lexan®, rubber, vinyl, leather, wood, marble, tile, glass, and fiberglass. This invention also may be used for mold release in the field of molding items made from fiberglass, plastic, rubber, and other similar materials.

### BACKGROUND ART

The application of a lustrous, protective wax or silicone coating to a coated or uncoated surface may be considered to include two processes: cleaning the surface and coating the surface. As used herein, “cleaning” refers to the removal of dirt through conventional washing with soap or detergent or by very gentle abrasive action. “Coating” refers to the application of one or more waxes, silicone resins, or similar coatings that adhere to the subject surface, protect the surface against damage, and help to prevent dirt and other deposits from sticking to the surface. “Polishing” refers to the use of abrasives to remove dirt and other deposits that cannot be removed by cleaning. Polishing optionally may be performed in preparation for coating.

Conventionally, abrasives and compounds containing abrasives have been used for polishing. Abrasives have also been used in compounds and formulations for coating to help polish the surface while a coating is being applied. Many abrasives, whether they are used in polishing compounds or in coating compounds, may damage the surface.

The background art that is most relevant to applicant's invention is the art of coating compositions. Compositions for coating have been available for many years. Conventional coating compositions generally fall into two principal categories: (1) compositions containing volatile organic compounds (VOCs) and (2) compositions containing water. Conventional coating compositions have disadvantages related to the presence of substantial amounts of VOCs or water.

Some conventional coating compositions, sold as pastes or liquids, are dispersions containing abrasives, wax, and one or more VOCs, which are used as solvents to dissolve the wax, silicone resin, or similar coatings. VOCs may cause health problems and environmental problems. VOCs are thus heavily regulated by governments. Users of compounds containing VOCs may need to use special equipment to maintain safety or to comply with governmental regulations. For all these reasons, it is desirable to prepare compositions that are suitable for coating surfaces but that contain minimal or no VOCs-less than about 5 percent by weight. Non-VOC hydrocarbons, a substitute for VOCs, require careful handling because they burn readily and have low flash points.

Other conventional coating compositions are emulsions containing abrasives, wax, water, and a surfactant or emulsifier commonly soap or detergent. These emulsions can be difficult to stabilize and commonly remain somewhat unstable, even when carefully formulated. High temperatures and low temperatures can cause these emulsions to “break” or separate into their component parts. Because these emulsions contain water, freezing can become an issue when they are processed, stored, or used at low temperatures. Therefore, it is desirable to provide a composition that is suitable for coating but contains little or no water—less than about 5 percent by weight.

Many conventional coating compounds are used by applying the compound to a surface, allowing the compound to dry by evaporation of the solvent, and then wiping the abrasive residue from the surface. The abrasive residue may create a health risk to the user. The vapors of the evaporating solvent may also pose a health risk to the user-especially if the solvent is a VOC. Users of compounds that require a drying process may be required to use additional equipment to protect themselves or to comply with governmental regulations. Therefore, it is desirable to produce coating compounds that contain abrasives but do not leave a dry abrasive residue upon the coated surface.

Finally, many conventional coating compounds contain soap or detergent. The presence of soap or detergent may hinder the coating process. Thus, it is desirable to produce compounds that are suitable for coating surfaces but contain minimal or no soap or detergent—less than about 10 percent by weight

U.S. Pat. No. 4,404,035 to Ona, et al. discloses a homogeneous mixture of a wax and an organopolysiloxane. But like all conventional coating compositions, the composition disclosed in Ona contains VOCs or emulsifiers that the present invention does not require.

U.S. Pat. No. 5,837,058 to Lowe discloses a VOC-free coating composition, but the composition contains substantial amounts of water and thus is subject to the freezing and instability referred to above. Lowe does not disclose a plastic polishing tool, nor does Lowe assert that the compound is useful for cleaning or polishing a surface.

VOC-free hydrocarbon solvents have become available, but many of these solvents burn readily and have low flash points. These characteristics also require careful use to ensure safety.

The background art includes polishing tools that are made from flexible plastic materials with abrasive particles dispersed therein. These tools do not apply a protective coating to the surface being polished. For example, U.S. Pat. Nos. 5,476,416 and 5,727,993 to Kodate disclose polishing tools made from a plastic material having abrasives and synthetic detergent powder dispersed therein. U.S. Pat. No. 5,676,714 to Kodate discloses a similar tool that contains a soft plastic material, abrasive particles, and non-abrasive globular particles. Kodate's tools do not aid the user in coating the surface with a lustrous, protective wax or silicone coating. Kodate's tools require the user who wants to apply a lustrous coating to employ an additional process after using Kodate's tools to clean and polish the surface.

The background art includes a polishing clay that is described in an advertisement as having properties similar to those claimed for Kodate's plastic polishing tools. The advertisement, which discloses a pliable “clay” cleaning material, a sponge pad with an elastic band for use in handling the material, and a liquid lubricant (ingredients not specified) used with the pliable cleaning material. The advertisement discloses a material that is useful in cleaning a surface, but not in applying a coating to the surface. The material disclosed also requires the use of a liquid lubricant.

### DISCLOSURE OF INVENTION

Objects of the Invention

It is an object of this invention to provide a device and a system comprising a flexible composite for applying a lustrous, protective coating to a surface.

It is another object of the invention to provide a device and a system for applying a lustrous, protective coating to a surface while reducing or eliminating the use of volatile organic compounds (VOCs), water, and emulsifiers, including detergent and soap.

It is another object of the invention to provide a system for applying a lustrous, protective coating to a surface, the system comprising a flexible composite material for applying the coating and a rejuvenator fluid to help maintain the properties of the composite as it is used.

It is another object of the invention to provide a device and a system for applying a lustrous, protective coating to a surface while minimizing the formation of abrasive residue upon the coated surface.

It is another object of the invention to provide a device and system for applying, to a metal mold, a non-corrosive, dry-film, anti-stick layer that improves the release of molded plastic, fiberglass, and rubber parts.

Disclosure: Invention in General

To achieve these and other advantages and objects, and in accordance with the purposes of the invention as embodied and broadly described herein, in one aspect the inventor describes a device comprising a composite material comprising a flexible plastic matrix; one or more silicone fluids; a surface coating containing one or more substances chosen from either or both of the following groups: waxes and silicones; and a multiplicity of one or more types of inert particles, preferably silica sand and aluminum silicate.

The invention may take the form of a system comprising the device and further comprising a rejuvenator fluid for maintaining the properties of the composite during use. The composite is adapted so that it has a wax penetration point measurement from about 60 mm to about 250 mm at 25 degrees Celsius under ASTM Test Method D217-82 (ASTM Committee D-2 on Petroleum Products and Lubricants and IP Standardization Committee, Subcommittee D02.0 on Lubricating Grease, approved Aug. 27, 1982, originally published October 1982, edited October 1983; the cited method appears in 1984 Annual Book of ASTM Standards; this is the version of the test method referred to throughout this application). The composite is adapted so that, when rubbed upon a surface, the device deposits the surface coating upon the surface.

Applicant's invention provides a lustrous surface coating to a surface. Applicant's invention comprises a device containing a flexible, water-resistant composite that is suitable for use on a wide variety of surfaces. The invention is suitable not only for coating metal or painted surfaces but also for coating plastic, plexiglass®, formica®, lexan®, rubber, vinyl, leather, wood, marble, tile, glass, and fiberglass.

Applicant's invention comprises a device comprising a flexible composite material adapted for cleaning and coating. The device comprises a portion of applicant's composite material. The portion of the composite material may have a shape, such as oblong or oval, selected for convenient handling by a user. The composite material contains everything that is necessary for coating a prepared surface. One or more substances—waxes or silicone resins or both—form the surface coating. One or more silicone fluids form a layer on the surface of the composite material and operate as a lubricant. Particles of one or more mild abrasives help to clean the surface; they also help to establish a lubricating layer of silicone on the surface of the composite material and to distribute the coating onto the surface. The plastic matrix allows the composite material (and hence the device) to conform to the surface being cleaned and coated. A soft texture of the composite minimizes scratching of the surface. Use of the composite allows application of a surface coating without dissolving or dispersing the coating in VOCs or emulsifying the coating in water.

The device may be used alone; the user simply rubs the device across the surface to be coated. The device may also be used with water or other liquid to lubricate the surface. Optionally, for best results, the surface should be cleaned before the coating process is begun.

Applicant's invention may also take the form of a system that comprises the composite, a rejuvenator fluid to be applied to the composite to renew and maintain its properties, and, optionally, an applicator pad to help moisten the composite with rejuvenator fluid.

Disclosure: Composite

Applicant's device comprises a composite that in turn comprises, at a minimum, a flexible plastic matrix, a silicone fluid, an abrasive, and a coating.

The matrix is formed of a mixture of one or more non-volatile resin polymers, which may be made by conventional chemical synthesis or purchased from suppliers of industrial chemicals. Examples of suitable matrix materials include: rosin and petroleum-derived resins such as poly-limonene, poly-alpha-pinene, poly-beta-pinene, polyethylene, polybutene, and polyterpene; hydrogenated resins; and modified styrene resins. Any suitable combination of these materials may be used. The matrix is selected so that the composite has a wax penetration point measurement from about 60 mm to about 250 mm at 25 degrees Celsius under ASTM Test Method D217-82.

The composite comprises a silicone fluid. A silicone fluid of the composite may be any silicone fluid, including organopolysiloxane fluid and alkylaurylsiloxane fluid, or any suitable combination of silicone fluids.

The composite contains mild, inert polishing abrasives, which help create a clean finish. The abrasives comprise a multiplicity of inert particles selected to avoid damaging the surface being coated. Examples of suitable abrasives include alumina, silica, silicates, silicon carbide, beryllium oxides, clay, calcium carbonate, pumice, earth, calcium-containing metal abrasives or abrasives containing metal oxides. Any combination of suitable abrasives can be used.

The composite also comprises a surface coating, which may comprise any wax substance, including the following: animal waxes such as beeswax or spermaceti; ceramic wax; plant waxes such as carnauba wax or candilla wax; mineral waxes such as ozokerite wax or ceresin wax, Montan wax, paraffin wax, or microcystalline wax; synthetic waxes such as oxides of paraffin wax or their esters; cane sugar-aliphatic acid ester waxes; polyol ether esters; higher alcohols-higher aliphatic acid waxes; and chlorinated napthalenes. In addition, the surface coating component of the composite may comprise a silicone resin. Any suitable combination of waxes, silicone resins, or waxes and silicone resins may be used.

Advantages Gained by Reduction or Elimination of Undesirable Components From Composite

The composite may include VOCs (volatile organic compounds), but preferably it contains as little VOC as possible—only the amount found in the materials used to make the composite. It is preferable to minimize VOCs because VOCs present health and environmental hazards, are heavily regulated by governments, and may require users to employ special protective equipment. The composite may contain non-VOC hydrocarbon solvents, but preferably it does not because non-VOC hydrocarbon solvents may require special equipment or handling because they burn readily and have low flash points.

The composite may also include detergent or soap, but preferably it does not because the presence of detergent or soap may reduce the luster or the protective qualities of the coating formed by use of the invention.

The composite may include some water, particularly as a trace ingredient in some materials used for making the invention. But the composite preferably contains much less water than a water-based emulsion, thus avoiding instability and freezing as described above.

Unlike conventional coating compositions, the composite does not require the use of volatile organic compounds (VOCs). The composite also does not require water or a non-VOC hydrocarbon solvent, and it does not require emulsifiers such as detergent or soap. Because the composite allows coating to be performed with minimal water, detergent, VOCs, non-VOC hydrocarbon solvents, and soap, or with no water, detergent, VOCs, non-VOC hydrocarbon solvents, or soap, the composite provides substantial advantages compared to prior compositions for coating.

Applicant's invention is a significant advance in the field of applying coatings to surfaces; applicant's invention substantially eliminates VOCs, non-VOC hydrocarbon solvents, water, and surfactants—one or more of which is found in all conventional coating compounds. Although applicant's device bears some similarity to Kodate's cleaning tools and other background-art cleaning tools that were described above, applicant's invention is for coating a surface—a purpose not addressed by Kodate. Moreover, Kodate's tool requires the presence of detergent, soap, or non-abrasive globular particles (in addition to the abrasive particles) that applicant's invention does not require. The superficial similarity between applicant's composite and Kodate's tool for cleaning and polishing should not obscure the advance that applicant has made in the art of coating.

To applicant's knowledge, applicant's composite is the first coating composition that allows the user to apply a wax coating without requiring VOCs, non-VOC hydrocarbon solvents, water, or surfactants (beyond trace amounts). To applicant's knowledge, applicant's composite is the first coating composition to include a wax or silicone resin coating and silicone fluid with no requirement to include VOCs, non-VOC hydrocarbon solvents, water, or surfactants (beyond trace amounts). Furthermore, to applicant's knowledge, applicant's composite is the first coating compound to allow application of a wax or silicone resin coating using a soft, flexible plastic composite.

Disclosure: Rejuvenator Fluid

Optionally, applicant's invention may take the form of a system comprising the device described above, a rejuvenator fluid for maintaining the properties of the composite, and optionally an applicator pad or other absorbent item. The rejuvenator fluid comprises a solution comprising silicone and wax. When applied to the composite, the rejuvenator fluid maintains and renews the properties of the composite by replacing wax and silicone fluid that are consumed in coating the surface. Preferably the silicone fluid is a water solution containing an emulsifier in addition to the wax and the silicone fluid. Suitable emulsifiers include the amine acetates—preferably acetic acid salts of the n-alkyl amines.

The rejuvenator fluid may be applied to the composite by spraying, dipping, or otherwise. An advantageous method for using the rejuvenator fluid is to moisten an absorbent material, such as a standard cloth-covered-sponge applicator pad, with the rejuvenator fluid; to place the device on the absorbent material; and then to hold the absorbent material in the hand along with the device during coating. The rejuvenator fluid contained in the absorbent material thus continuously renews the properties of the composite, extending its life and improving its performance. Another advantageous method includes attaching the composite with a rubber band to an absorbent pad equipped with an elastic band for securing the pad to the user's wrist, then moistening the pad with the rejuvenator fluid.

The background art includes the use of lubricating fluids and absorbent pads (including those with elastic for attachment to a user's hand) along with pliable cleaning materials. But the background-art lubricant fluids are not used in a coating process and are not used to restore coating or other properties of a composite.

Both the foregoing general description and the following detailed description are exemplary and explanatory only and do not restrict the invention as claimed.

### BRIEF DESCRIPTION OF THE SEVERAL VIEWS OF THE DRAWINGS

FIG. 1 is a perspective view of an embodiment of a device in the form of a portion of a composite material according to the invention.

FIG. 2 is a schematic, greatly magnified, view of a portion of the surface of an embodiment of a portion of a composite material according to the invention.

FIG. 3 is a side view of an embodiment of a portion of a composite material according to the invention depicted in a working position in contact with a surface.

FIG. 4 is a perspective view of a first step in the use of an embodiment of the system of the invention comprising an applicator pad and a portion of a composite according to the invention.

FIG. 5 is a perspective view of a second step in the use of an embodiment of the system of the invention comprising an applicator pad and a portion of a composite according to the invention.

FIG. 6 is a perspective view of a third step in the use of an embodiment of the system of the invention comprising an applicator pad and a portion of a composite according to the invention.

FIG. 7 is a perspective view of an alternative embodiment of an applicator pad for use in the system of the invention.

FIG. 8 is a perspective view of an alternative embodiment of an applicator pad and a portion of a composite for use in the system of the invention.

### MODES FOR CARRYING OUT THE INVENTION

The device according to the present invention comprises a flexible composite with an ASTM:D217-82 cone penetration measurement from about 60 mm to about 250 mm at 25 degrees Celsius (77 degrees Fahrenheit). The composite comprises a flexible plastic matrix; one or more silicone fluids; one or more surface coatings; and a multiplicity of one or more types of abrasive particles. The invention may take the form of a system comprising the device and further comprising an applicator pad and rejuvenator fluid.

In the preferred embodiment, the device of the invention comprises a generally oblong portion of the composite of the invention. The device is shaped so that it is convenient for the user to handle it and rub it across a surface to be coated. One composite according to the invention comprises a matrix of polybutene, polyterpene, and polyethylene; a silicone fluid; a wax; and silica sand and aluminum silicate. This embodiment is more durable than the tools disclosed in Kodate's patents, which were discussed above.

The applicator pad may comprise a standard item comprising a cellulose-type sponge. The sponge may be covered with fabric. Applicator pads are commonly used to apply wax-containing preparations to surfaces. Other absorbent items such as cloth rags may be used as applicator pads.

One embodiment of the system of the invention is adapted for especially convenient handling by the user. This embodiment comprises an improved applicator pad adapted for convenient handling of the composite. The improved system comprises an applicator pad that is an essentially rectangular piece of foam. One face of the foam has attached thereto an elastic band adapted to be slipped over the fingers of a user. To use the system, one places the composite on the face of the applicator pad opposite the elastic band and secures the composite to the applicator pad with one or more fasteners. Elastic fasteners such as rubber bands have proven effective.

A preferred embodiment of the rejuvenator fluid contains about 0.3% wax, 0.5% polydimethylsiloxane, 0.5% acetic acid salts of the n-alkyl amines. The remainder of the rejuvenator primarily comprises water, along with small amounts of dye, fragrance, and preservative.

One embodiment of the composite of the invention can be prepared by mixing the following (“parts” being defined as parts by mass): (a) about 4 parts of any combination of waxes and silicone resins; (b) about 36 parts of any combination of silicone fluids; (c) about 32 parts polybutene; (d) about 3 parts polyterpene; and (e) about 3 parts polyethylene plastic. After these components have been blended, the mixture may be added to about 100 parts of any combination of inert particles, but preferably to about one part silica sand combined with about 99 parts aluminum silicate. The total weight of the finished composition is about 178.25 parts.

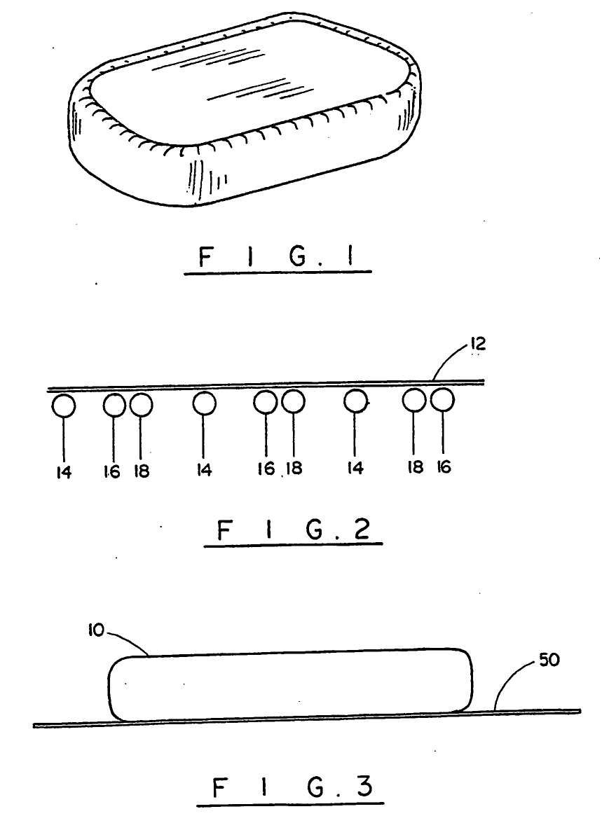

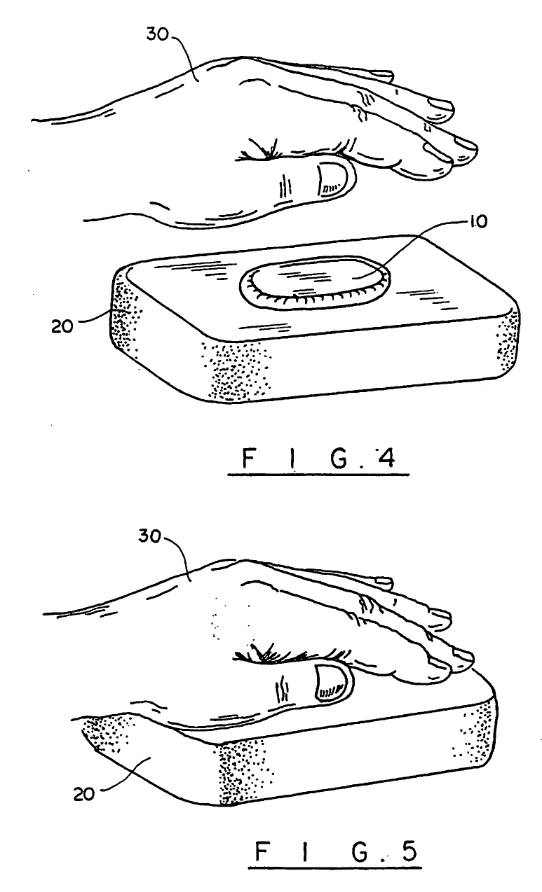

In the drawings, FIG. 1 shows the device 10, a generally oblong portion of the composite of the invention. FIG. 2 shows a greatly magnified segment of surface 12 of the device, the surface 12 having a thin layer of a mixture of wax 14, abrasive 16, and silicone 18. As illustrated in FIG. 2, silicone 18 and the abrasive 16 tend to be attracted to each other and tend to repel wax 14. This interaction helps to deposit wax 14 on a surface 50, shown in FIG. 3, that is treated with the device 10.

FIG. 3 shows the device 10 in a working position in contact with a surface 50 that is to be coated.

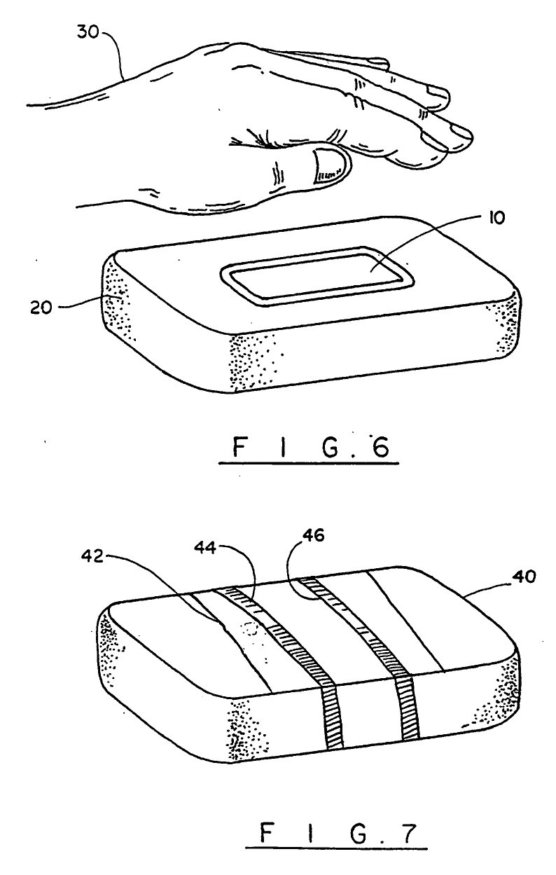

FIGS. 4 through 6 show three steps that may be employed in using an embodiment of the device 10 as part of an embodiment of a system comprising device 10 and applicator pad 20. FIG. 4 illustrates a first step in using the system; device 10 is placed in a working position atop applicator pad 20. As shown in FIG. 5, the user then applies pressure by hand 30 to press the device 10 onto the applicator pad 20, causing the device 10 to weakly adhere to the applicator pad 20 and to flatten and spread, as shown in FIG. 6. Optionally, the device 10 and pad 20 may then be moistened with rejuvenator fluid (not shown). Finally, the user, holding the applicator pad 20, rubs the device 10 on a surface and thereby applies a coating to the surface.

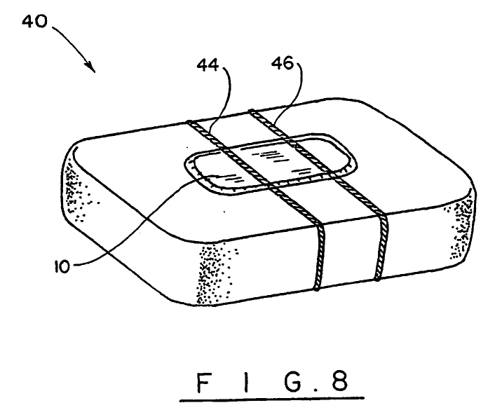

FIG. 7 shows an alternative embodiment of a system according to the invention, wherein alternative applicator pad 40 has elastic band 42 sewn thereto and elastic fasteners 44 and 46 attached thereto.

FIG. 8 shows the embodiment of FIG. 7 in an inverted position with respect to the view of FIG. 7. Elastic fasteners 44 and 46 secure device 10 to alternative applicator pad 40.

1. A device for applying a protective coating to a surface, comprising:
a composite, comprising:
a matrix comprising at least one polymer resin selected from the group consisting of hydrocarbon, polybutene, silicone, and polyethylene;
at least one silicone fluid;
a surface coating comprising at least one material selected from the group consisting of wax, silicone resin; and
a multiplicity of inert particles dispersed within the matrix;
wherein the composite has a wax penetration point measurement from about 60 mm to about 250 mm at 25 degrees Celsius [under ASTM Test Method D217]; and
wherein the device is adapted to be rubbed upon the surface to provide coating on the surface.

2. A device according to claim 1, wherein the inert particles comprise at least one material selected from the group consisting of aluminum silicate, diatomaceous earth, and aluminum oxide.

3. A device according to claim 1, wherein the inert particles comprise at least two materials selected from the group consisting of aluminum silicate, diatomaceous earth, and aluminum oxide.

4. A device according to claim 1, wherein the composite contains less than about 5 percent by weight of volatile organic compounds and less than about 5 percent non-volatile hydrocarbon solvents.

5. A device according to claim 1, wherein the sum of the weight percentages of all soaps and detergents contained in the composite is less than about 10 percent.

6. A device according to claim 1, wherein the weight of the inert particles is between about 40 percent and about 80 percent of the total weight of the composite material.

7. A device according to claim 1, wherein the silicone fluid comprises at least one fluid selected from the group consisting of polydimethylsiloxane fluid, dimethyl siloxane polymer fluid, alkymethyl polysiloxane fluid, dimethylsiloxane fluid, and amine functional silicone fluid.

8. A device according to claim 1, wherein the composite contains less than about 1 percent by weight of volatile organic compounds.

9. A device according to claim 1, wherein the composite is adapted so that it has formed on its surface a layer of silicone fluid.

10. A device according to claim 9, wherein the coating of silicone fluid, which forms on the surface of the composite, has a multiplicity of inert particles distributed in the coating of silicone fluid.

11. A device according to claim 1, wherein the composite maintains its flexibility upon exposure to the atmosphere.

12. A device according to claim 1, wherein the composite maintains its lubricant content upon exposure to the atmosphere.

13. A device according to claim 1, wherein the composite is adapted to conform to the shape of the surface upon which the device is rubbed.

14. A device according to claim 1, wherein the inert particles are selected to minimize scratching of the surface upon which the device is rubbed.

15. A device according to claim 1, wherein the device is adapted so that the device, when rubbed upon the surface, deposits a durable, water-resistant coating thereupon.

16. A device according to claim 1, wherein emulsifiers constitute less than about 10 percent by weight of the composite.

17. A device according to claim 1, wherein water constitutes less than about 5 percent of the composite.

18. A system for applying a protective coating to a surface, comprising:
a device for applying a protective coating to the surface, the device comprising:
a composite, the composite comprising:
a matrix comprising at least one polymer resin chosen from the following group: hydrocarbon, polybutene, silicone, polyethylene;
at least one silicone fluid;
a surface coating comprising at least one material selected from the following groups: wax, silicone resin; and
a multiplicity of inert particles dispersed within the matrix;
wherein the composite has a wax penetration point measurement from about 60 mm to about 250 mm at 25 degrees Celsius under ASTM Test Method D217; and
wherein the device is adapted to be rubbed upon the surface to coat the surface (with the coating);
an applicator pad; and
a rejuvenator fluid comprising a silicone and a wax.

19. A system for applying a protective coating to a surface according to claim 18, wherein the rejuvenator fluid further comprises an emulsifier.

20. A system according to claim 19, wherein the emulsifier component in the rejuvenator fluid comprises an acetic acid salt of the n-alkyl amines.

21. A system according to claim 18, 19, or 20, wherein the composite contains less than about 1 percent by weight of volatile organic compounds.

22. A system according to claim 18, 19, or 20, wherein the weight of the inert particles is between about 40 percent and about 80 percent of the total weight of the composite material.

23. A system according to claim 18, 19, or 20, wherein the silicone (fluid) is selected from the group consisting of polydimethylsiloxane fluid, dimethyl siloxane polymer fluid, alkymethyl polysiloxane fluid, dimethylsiloxane fluid, and amine functional silicone fluid.

24. A system according to claim 18, 19, or 20, wherein the composite is water-resistant.

25. A system according to claim 18, 19, or 20, wherein the composite has formed a layer of silicone fluid on its surface.

26. A system according to claim 18, 19, or 20, wherein the composite has formed a layer of silicone fluid on its surface and wherein the coating of silicone fluid, which forms the exterior surface of the composite, has a multiplicity of the inert particles distributed in the coating of silicone fluid.

27. A system according to claim 18, 19, or 20, wherein the composite maintains its flexibility upon exposure to the atmosphere.

28. A system according claim 18, 19, or 20, wherein the composite maintains its lubricant content upon exposure to the atmosphere.

29. A system according to claim 18, 19, or 20, wherein the composite conforms to the shape of a surface upon which the device is rubbed.

30. A system according to claim 18, 19, or 20, wherein the inert particles are selected to minimize scratching of the surface upon which the device is rubbed.

31. A system according to claim 18, 19, or 20, wherein the device deposits a durable, water-resistant coating upon the surface on which it is rubbed.

32. A system according to claim 18, 19, or 20, wherein emulsifiers constitute less than about 10 percent by weight of the composite.

33. A method for applying a protective coating to a surface, comprising:
rubbing the surface with the device claimed in claim 1.

34. A method for applying a protective coating to a surface, comprising:
using the system claimed in claim 17.

35. A device according to claim 1, wherein the matrix comprises polybutene, polyterpene, and polyethylene.

36. A device for application of a mold-release coating to a mold, comprising:
a composite, comprising:
a matrix comprising at least one polymer resin selected from the group consisting of hydrocarbon, polybutene, silicone, and polyethylene;
at least one silicone fluid;
a surface coating comprising at least one material selected from the group consisting of wax and silicone resin; and
a multiplicity of inert particles dispersed within the matrix;
wherein the composite has a wax penetration point measurement from about 60 mm to about 250 mm at 25 degrees Celsius under ASTM Test Method D217; and
wherein the device is adapted so that the device, when rubbed upon a surface, leaves a mold-release coating on the surface when rubbed thereon.

37. A device according to claim 1, wherein the inert particles have diameters of about 0.1 to about 3 microns or diameters greater than 50 microns, or both.

38. A device according to claim 1, wherein the composite is water-resistant.

39. A system according to claim 18, 19, or 20, wherein the inert particles have diameters of from 0.1 to 3 microns, or diameters greater than 50 microns, or both.

40. A method according to claim 34, wherein the composite contains less than 1 percent by weight of volatile organic compounds.

41. A device for applying a protective coating to a surface, comprising a portion of composite material consisting essentially of:
about 32 parts by weight of polybutene;
about 3 parts by weight polyterpene;
about 3 parts by weight polyethylene plastic;
about 4 total parts by weight of plastic or silicone resin or both;
about 100 total parts by weight of inert particles.

42. A device according to claim 41, wherein the inert particles consist essentially of a part silica sand and 99 parts aluminum silicate.
